(19) United States
(12) Patent Application Publication
(10) Pub. No.: US 2002/0079753 A1
(43) Pub. Date: Jun. 27, 2002

(54) High thermal conductivity spaceblocks for increased electric generator rotor endwinding cooling

(76) Inventors: Wayne Nigel Owen Turnbull, Clifton Park, NY (US); Todd Garrett Wetzel, Niskayuna, NY (US); Christian Lee Vandervort, Voorheesville, NY (US); Samir Armando Salamah, Niskayuna, NY (US); Emil Donald Jarczynski, Scotia, NY (US)

Correspondence Address: NIXON & VANDERHYE P.C., 8th Floor, 1100 North Glebe Road, Arlington, VA, 22201, US

(21) Appl. No.: 09/741,895

(22) Filed: Dec. 22, 2000

(51) Int. Cl. H02K 9/00

(52) U.S. Cl. 310/61

(57) ABSTRACT

A gas cooled dynamoelectric machine is provided that is comprised of a rotor, a rotor winding comprising axially extending coils and concentric endwindings, and a plurality of spaceblocks located between adjacent endwindings thereby to define a plurality of cavities, each bounded by adjacent spaceblocks and adjacent endwindings. To enhance the heat transfer rate from the copper end turns of the field endwinding region, one or more of the spaceblocks are formed from or coated with a high thermal conductivity material to improve heat transfer from the endwindings engaged therewith.

### BACKGROUND OF THE INVENTION

The present invention relates to a structure for enhancing cooling of generator rotors.

The power output rating of dynamoelectric machines, such as large turbo-generators, is often limited by the ability to provide additional current through the rotor field winding because of temperature limitations imposed on the electrical conductor insulation. Therefore, effective cooling of the rotor winding contributes directly to the output capability of the machine. This is especially true of the rotor end region, where direct, forced cooling is difficult and expensive due to the typical construction of these machines. As prevailing market trends require higher efficiency and higher reliability in lower cost, higher-power density generators, cooling the rotor end region becomes a limiting factor.

Turbo-generator rotors typically consist of concentric rectangular coils mounted in slots in a rotor. The end portions of the coils (commonly referred to as endwindings), which are beyond the support of the main rotor body, are typically supported against rotational forces by a retaining ring (see FIG. 1). Support blocks are placed intermittently between the concentric coil endwindings to maintain relative position and to add mechanical stability for axial loads, such as thermal loads (see FIG. 2). Additionally, the copper coils are constrained radially by the retaining ring on their outer radius, which counteracts centrifugal forces. The presence of the spaceblocks and retaining ring results in a number of coolant regions exposed to the copper coils. The primary coolant path is axial, between the spindle and the bottom of the endwindings. Also, discrete cavities are formed between coils by the bounding surfaces of the coils, blocks and the inner surface of the retaining ring structure. The endwindings are exposed to coolant that is driven by rotational forces from radially below the endwindings into these cavities (see FIG. 3). This heat transfer tends to be low. This is because according to computed flow pathlines in a single rotating endwinding cavity from a computational fluid dynamic analysis, the coolant flow enters the cavity, traverses through a primary circulation and exits the cavity. Typically, the circulation results in low heat transfer coefficients especially near the center of the cavity. Thus, while this is a means for heat removal in the endwindings, it is relatively inefficient.

Various schemes have been used to route additional cooling gas through the rotor end region. All of these cooling schemes rely on either (1) making cooling passages directly in the copper conductors by machining grooves or forming channels in the conductors, and then pumping the gas to some other region of the machine, and/or (2) creating regions of relatively higher and lower pressures with the addition of baffles, flow channels and pumping elements to force the cooling gas to pass over the conductor surfaces.

Some systems penetrate the highly stressed rotor retaining ring with radial holes to allow cooling gas to be pumped directly alongside the rotor endwindings and discharged into the air gap, although such systems can have only limited usefulness due to the high mechanical stress and fatigue life considerations relating to the retaining ring.

If the conventional forced rotor end cooling schemes are used, considerable complexity and cost are added to rotor construction. For example, directly cooled conductors must be machined or fabricated to form the cooling passages. In addition, an exit manifold must be provided to discharge the gas somewhere in the rotor. The forced cooling schemes require the rotor end region to be divided into separate pressure zones, with the addition of numerous baffles, flow channels and pumping elements—which again add complexity and cost.

If none of these forced or direct cooling schemes are used, then the rotor endwindings are cooled passively. Passive cooling relies on the centrifugal and rotational forces of the rotor to circulate gas in the blind, dead-end cavities formed between concentric rotor windings. Passive cooling of rotor endwindings is sometimes also called “free convection” cooling.

Passive cooling provides the advantage of minimum complexity and cost, although heat removal capability is diminished when compared with the active systems of direct and forced cooling. Any cooling gas entering the cavities between concentric rotor windings must exit through the same opening since these cavities are otherwise enclosed—the four “side walls” of a typical cavity are formed by the concentric conductors and the insulating blocks that separate them, with the “bottom” (radially outward) wall formed by the retaining ring that supports the endwindings against rotation. Cooling gas enters from the annular space between the conductors and the rotor spindle. Heat removal is thus limited by the low circulation velocity of the gas in the cavity and the limited amount of the gas that can enter and leave these spaces.

In typical configurations, the cooling gas in the end region has not yet been fully accelerated to rotor speed, that is, the cooling gas is rotating at part rotor speed. As the fluid is driven into a cavity by means of the relative velocity impact between the rotor and the fluid, the heat transfer coefficient is typically highest near the spaceblock that is downstream relative to the flow direction where the fluid enters with high momentum and where the fluid coolant is coldest. The heat transfer coefficient is also typically high around the cavity periphery. The center of the cavity receives the least cooling.

Increasing the heat removal capability of passive cooling systems will increase the current carrying capability of the rotor providing increased rating capability of the generator whole maintaining the advantage of low cost, simple and reliable construction.

U.S. Pat. No. 5,644,179, the disclosure of which is incorporated by reference describes a method for augmenting heat transfer by increasing the flow velocity of the large single flow circulation cell by introducing additional cooling flow directly into, and in the same direction as, the naturally occurring flow cell. While this method increases the heat transfer in the cavity by augmenting the strength of the circulation cell, the center region of the rotor cavity was still left with low velocity and therefore low heat transfer. The same low heat transfer still persists in the corner regions.

### SUMMARY OF THE INVENTION

The invention enhances the heat transfer rate from the copper end turns of the field endwinding region by using high thermal conductivity spaceblocks in a generator endwinding assembly to promote better heat removal from the cavities, including the corner regions, thus substantially enhancing the low heat transfer rates currently experienced. Improving cooling of the end turns in this region will provide the opportunity to increase the power output rating of a given machine leading to an improved cost basis on a dollar per kilowatt-hour basis. As the endwinding region is usually limiting in terms of satisfying maximum temperature constraints, improvements in this region should produce significant performance benefits.

The high thermal conductivity spaceblocks are either formed from a high thermal conductivity, or coated with such a material, to facilitate the transfer of thermal energy from the end turns to the fluid regions within the cavities by increasing the surface area available for heat transfer to the circulating cooling fluid. Preferably, the material of the spaceblock and/or its coating is also a high electrical resistance material. In the alternative, the spaceblock or its coating can be bisected by a suitable insulator so that no direct electrical path exists between coils at different potential.

Accordingly, the invention is embodied in a gas cooled dynamoelectric machine, that comprises a rotor having axially extending coils, end turns defining a plurality of endwindings; and at least one spaceblock located between adjacent the endwindings so as to define a cavity therebetween. The spaceblock is either formed from or has a surface layer comprised of a material having high thermal conductivity.

### BRIEF DESCRIPTION OF THE DRAWINGS

These, as well as other objects and advantages of this invention, will be more completely understood and appreciated by careful study of the following more detailed description of the presently preferred exemplary embodiments of the invention taken in conjunction with the accompanying drawings, in which:

FIG. 1 is a cross-sectional view of a portion of the end turn region of a dynamoelectric machine rotor with a stator in opposed facing relation thereto;

FIG. 2 is a cross-sectional top view of the dynamoelectric machine rotor, taken along line 2-2 of FIG. 1;

FIG. 3 is a schematic illustration showing passive gas flow into and through endwinding cavities;

FIG. 4 is a partial section of a rotor endwinding showing high thermal spaceblocks according to an embodiment of the invention.

FIG. 5 is a cross sectional view taken along line I-I of FIG. 4 illustrating a first embodiment of the invention;

FIG. 6 is a cross sectional view taken along line I-I of FIG. 4 illustrating a second embodiment of the invention; and

FIG. 7 is a cross sectional view taken along line I-I of FIG. 4 illustrating a third embodiment of the invention.

### DETAILED DESCRIPTION OF THE INVENTION

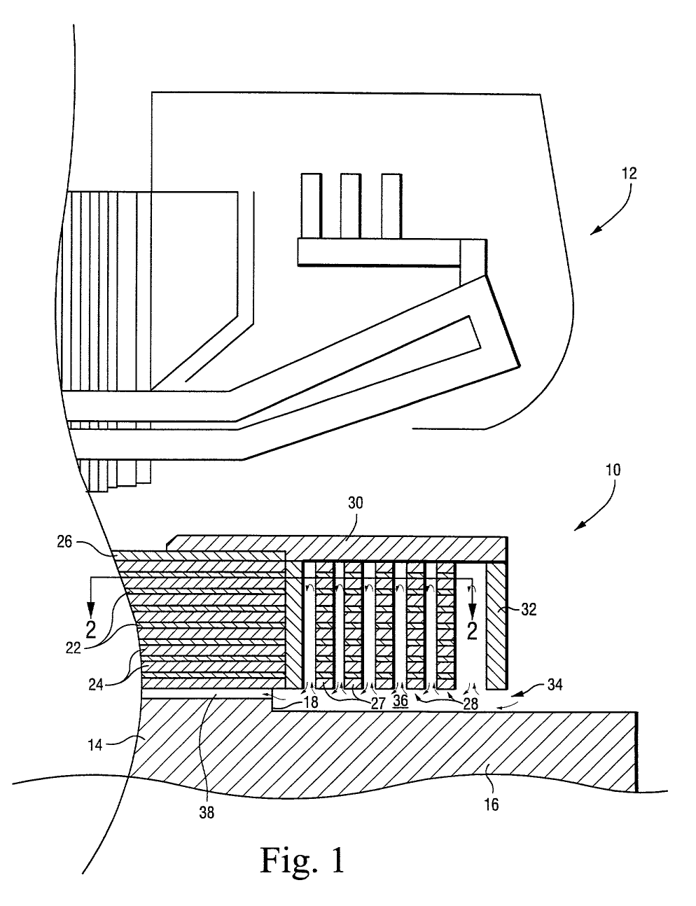

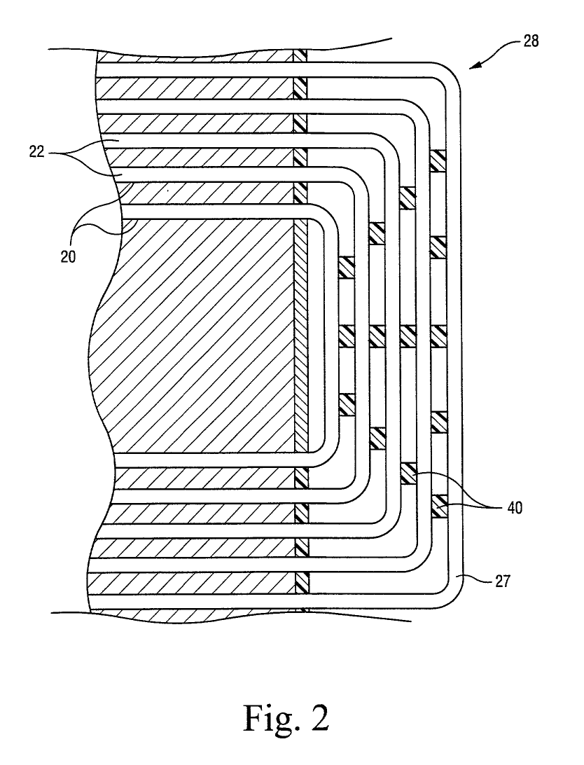

Referring to the drawings wherein identical reference numerals denote the same elements throughout the various views, FIGS. 1 and 2 show a rotor 10 for a gas-cooled dynamoelectric machine, which also includes a stator 12 surrounding the rotor. The rotor includes a generally cylindrical body portion 14 centrally disposed on a rotor spindle 16 and having axially opposing end faces, of which a portion 18 of one end face is shown in FIG. 1. The body portion is provided with a plurality of circumferentially-spaced, axially extending slots 20 for receiving concentrically arranged coils 22, which make up the rotor winding. For clarity, only five rotor coils are shown, although several more are commonly used in practice.

Specifically, a number of conductor bars 24 constituting a portion of the rotor winding are stacked in each one of the slots. Adjacent conductor bars are separated by layers of electrical insulation 22. The stacked conductor bars are typically maintained in the slots by wedges 26 (FIG. 1) and are made of a conductive material such as copper. The conductor bars 24 are interconnected at each opposing end of the body portion by end turns 27, which extend axially beyond the end faces to form stacked endwindings 28. The end turns are also separated by layers of electrical insulation.

Referring specifically to FIG. 1, a retaining ring 30 is disposed around the end turns 27 at each end of the body portion to hold the endwindings in place against centrifugal forces. The retaining ring is fixed at one end to the body portion and extends out over the rotor spindle 16. A centering ring 32 is attached to the distal end of the retaining ring 30. It should be noted that the retaining ring 30 and the center ring 32 can be mounted in other ways, as is known in the art. The inner diameter of the centering ring 32 is radially spaced from the rotor spindle 16 so as to form a gas inlet passage 34 and the endwindings 28 are spaced from the spindle 16 so as to define an annular region 36. A number of axial cooling channels 38 formed along slots 20 are provided in fluid communication with the gas inlet passage 34 via the annular region 36 to deliver cooling gas to the coils 22.

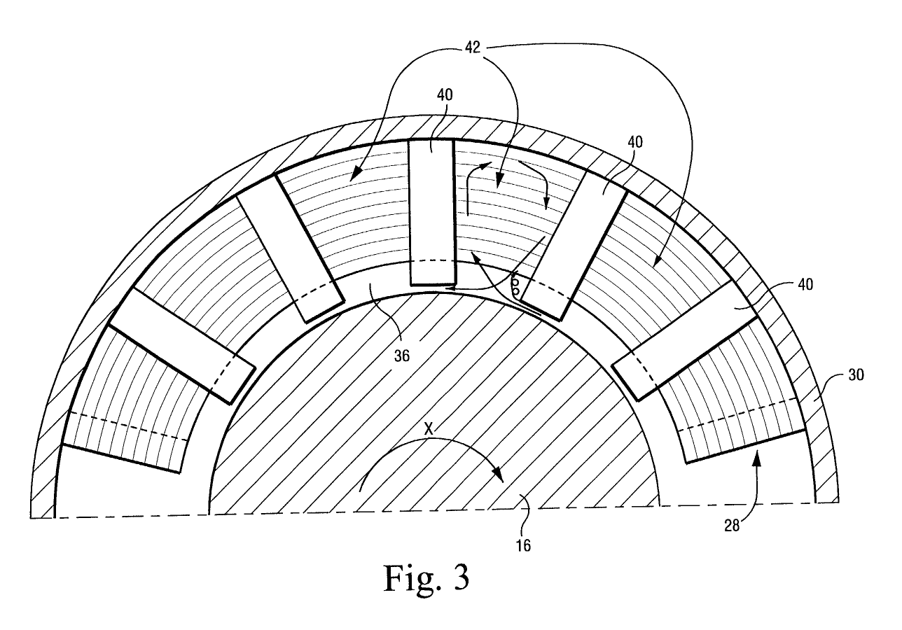

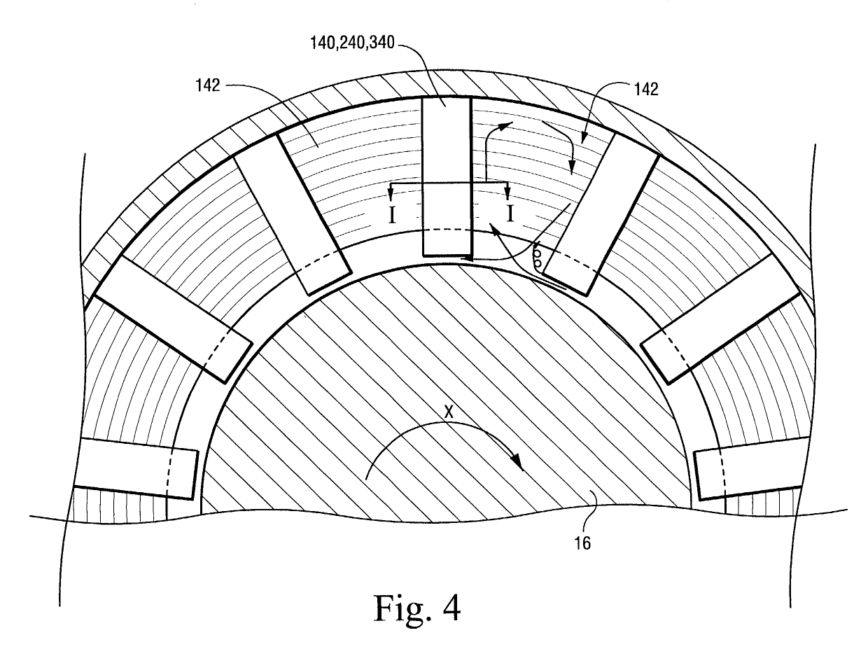

Turning to FIG. 2, the endwindings 28 at each end of the rotor 10 are circumferentially and axially separated by a number of spacers or spaceblocks 40. (For clarity of illustration, the spaceblocks are not shown in FIG. 1). The spaceblocks are elongated blocks of an insulating material located in the spaces between adjacent endwindings 28 and extend beyond the full radial depth of the endwindings into the annular gap 36. Accordingly, the spaces between the concentric stacks of the end turns 27 (hereinafter endwindings) are divided into cavities. These cavities are bounded on the top by the retaining ring 30 and on four sides by adjacent endwindings 28 and adjacent spaceblocks 40. As best seen in FIG. 1, each of these cavities is in fluid communication with the gas inlet passage 34 via the annular region 36. A portion of the cooling gas entering the annular region 36 between the endwinding 28 and the rotor spindle 16 through the gas inlet passage 34 thus enters the cavities 42, circulates therein, and then returns to the annular region 36 between the endwinding and the rotor spindle. Air flow is shown by the arrows in FIGS. 1 and 3.

Referring now to FIG. 6, there is illustrated a partial section of the rotor endwinding showing endwinding cavities 142 with the direction of rotation indicated by arrow X. In an embodiment of the invention, to improve generator field end winding cooling effectiveness, at least one and preferably each spaceblock 140, 240, 340 is made from a high thermal conductivity and high electrical resistance material, or comprises a surface layer of a material having high thermal conductivity and high electrical resistance. Spaceblocks 140, 240, 340 embodying the invention, in contact with the cavity walls defined by the end turns 27/endwindings 28, will facilitate the transfer of thermal energy from those walls to the fluid regions within the cavities 142 by increasing the surface area available for heat transfer to the circulating cooling fluid.

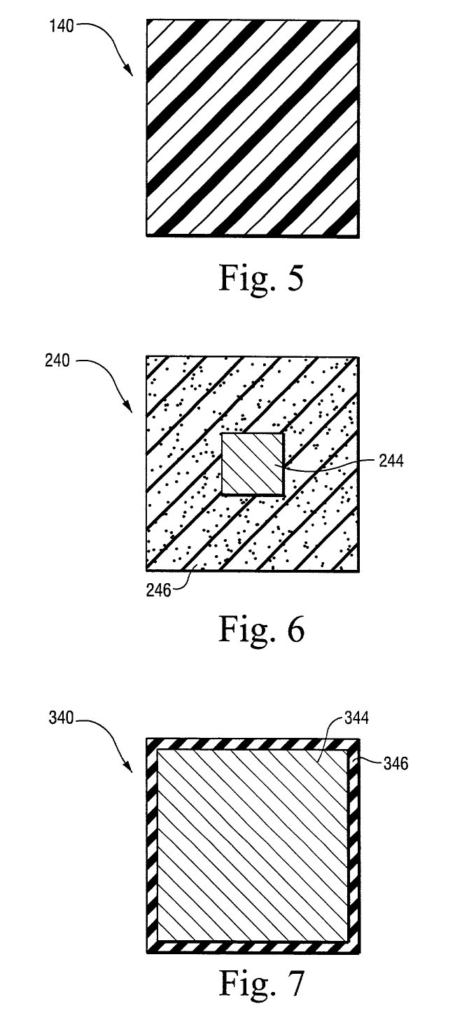

In a first exemplary embodiment of the invention, illustrated in FIG. 5, the spaceblock 140 generally corresponds in size and shape to a conventional spaceblock 40, but is formed from a high thermal conductivity plastic material, such as Konduit, a thermoplastic composite material, supplied by LNP Engineering Plastics of Exton, Pa. Konduit reportedly provides many times the thermal conductivity of typical thermoplastics. This enables heat to be radiated out and away from the endwindings. This material exhibits the further advantageous characteristic that it has a low coefficient of thermal expansion. (See, e.g., http://www.manufacturingcenter.com/med/archives/0900/0900dd.asp).

In a second exemplary embodiment of the invention, illustrated in FIG. 6, the spaceblock 240 comprises a high strength core 244 with a thick, high thermal conductivity surface layer 246. The solid core 244 provides the strength needed to keep the end turns of adjacent endwindings 28 apart. The thick surface layer 246, on the other hand, provides the enhanced heat transfer path for a higher heat transfer rate. In an exemplary embodiment, the core is formed from a suitably strong material, such as fiberglass filled epoxy (G-10), and the surface layer is a thick coating of high thermal conductivity foam, such as high thermal conductivity carbon foam. For example, Oak Ridge National Laboratory (ORNL) has developed a relatively simple technique for fabricating extremely high thermal conductivity carbon foams. (See http://www.ms.ornl.gov/ott/ee09.htm). Since this material reportedly exhibits compressive strengths comparable to Kevlar® honeycomb composites at similar densities, it may be possible in some implementations to omit the solid core 244, so that the spaceblock is formed entirely from high thermal conductivity carbon foam.

In a third exemplary embodiment, illustrated in FIG. 7, the spaceblock 340 is similar to the embodiment of FIG. 6, in that it is comprised of a core 344 with a high thermal conductivity surface layer 346. In this embodiment the spaceblock substrate or core 344 may be of the same or similar size, shape and material as a conventional spaceblock 40. To provide the desired high thermal conductivity to facilitate heat transfer, the core 344 is coated with a thin surface layer (or thick film) of high thermal conductivity material 346. Exemplary film materials to provide the desired high thermal conductivity include aluminum, copper, graphite, gold, silicon carbide, rhodium, silver, tungsten, zinc, diamond, beryllium oxide, magnesium oxide, molybdenum, high thermal conductivity plastic materials, of the type mentioned above with reference to FIG. 5, and high thermal conductivity carbon foams, of the type mentioned above with reference to FIG. 6.

In the case where the thick film coating is a high electrical resistance material, then the core 344 may be formed from a high thermal conductivity material, such as a metal to further enhance heat transfer. In the alternative, whether or not the thick film coating is a high electrical resistance material, the core 344 can be a material of the fibre-filled epoxy family, such as G-10.

As noted above, in a preferred embodiment, the spaceblock is formed from or is coated with a material that exhibits high thermal conductivity and high electrical resistance. Some of the materials identified above as suitable for the thick film coating exhibit high thermal conductivity with low electrical resistance. Those materials would be options where there is no problem with potential differences between coils, etc. If this is not the case, they may nevertheless be used, provided that the low electrical resistance material, whether it is the space block or its surface layer, is bisected by a suitable insulator, such as G-10 so that no direct electrical path exists between coils at different potential.

While the invention has been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the appended claims.

What is claimed is:

1. A gas cooled dynamoelectric machine, comprising:
a rotor having a body portion, said rotor having axially extending coils and end turns defining a plurality of endwindings extending axially beyond at least one end of said body portion; and
at least one spaceblock located between adjacent said endwindings so as to define a cavity therebetween,
wherein said spaceblock is one of 1) formed from and 2) has a surface layer comprised of a material having high thermal conductivity.

2. The dynamoelectric machine of claim 1, wherein said spaceblock is one of 1) formed from and 2) has a surface layer comprised of a material having high electrical resistance.

3. The dynamoelectric machine of claim 1, wherein said spaceblock is formed from a high thermal conductivity plastic material.

4. The dynamoelectric machine of claim 1, wherein said spaceblock comprises a high strength core having a surface layer comprising said high thermal conductivity material.

5. The dynamoelectric machine of claim 4, wherein said surface layer comprises a coating of a high thermal conductivity foam material.

6. The dynamoelectric machine of claim 5, wherein said surface layer comprises a high thermal conductivity carbon foam material.

7. The dynamoelectric machine of claim 4, wherein said surface layer comprises a film of high thermal conductivity material.

8. The dynamoelectric machine of claim 7, wherein said film of high thermal conductivity material comprises a material selected from the group consisting of aluminum, copper, graphite, gold, silicon carbide, rhodium, silver, tungsten, zinc, diamond, beryllium oxide, magnesium oxide, molybdenum, high conductivity plastic and high conductivity carbon foams.

9. The dynamoelectric machine of claim 1, wherein there are a plurality of spaceblocks, each said spaceblock being one of 1) formed from and 2) having a surface layer comprised of a material having high thermal conductivity and high electrical resistance.

10. A gas cooled dynamoelectric machine, comprising:
a rotor having a spindle and a body portion;
a rotor winding comprising axially extending coils disposed on said body portion and spaced, concentric endwindings extending axially beyond at least one end of said body portion, said endwindings and said spindle defining an annular space therebetween; and
a plurality of spaceblocks located between adjacent ones of said endwindings thereby to define a plurality of cavities, each bounded by adjacent spaceblocks and adjacent endwindings and open to said annular space;
wherein a cavity facing surface of at least one said spaceblock is one of 1) formed from and 2) has a surface layer comprised of a material having high thermal conductivity.

11. The dynamoelectric machine of claim 10, wherein said spaceblock is one of 1) formed from and 2) has a surface layer comprised of a material having high electrical resistance.

12. The dynamoelectric machine of claim 10, wherein said spaceblock is formed from a high thermal conductivity plastic material.

13. The dynamoelectric machine of claim 10, wherein said at least one said spaceblock comprises a high strength core having a surface layer comprising said high thermal conductivity material.

14. The dynamoelectric machine of claim 13, wherein said surface layer comprises a coating of a high thermal conductivity foam material.

15. The dynamoelectric machine of claim 14, wherein said surface layer comprises a high thermal conductivity carbon foam material.

16. The dynamoelectric machine of claim 13, wherein said surface layer comprises a film of high thermal conductivity material.

17. The dynamoelectric machine of claim 16, wherein said film of high thermal conductivity material comprises a material selected from the group consisting of aluminum, copper, graphite, gold, silicon carbide, rhodium, silver, tungsten, zinc, diamond, beryllium oxide, magnesium oxide, molybdenum, high conductivity plastic, and high conductivity carbon foams.

18. The dynamoelectric machine of claim 10, wherein a plurality of the spaceblocks are one of 1) formed from and 2) have a surface layer comprised of a material having high thermal conductivity and high electrical resistance.
